(19) United States
(12) Patent Application Publication
(10) Pub. No.: US 2011/0234817 A1
(43) Pub. Date: Sep. 29, 2011

(54) IMAGE CAPTURING TERMINAL, EXTERNAL TERMINAL, IMAGE CAPTURING SYSTEM, AND IMAGE CAPTURING METHOD

(75) Inventor: Akihiko SAKAMOTO, Sagamihara-shi (JP)

(73) Assignee: OLYMPUS CORPORATION, Tokyo (JP)

(21) Appl. No.: 13/069,082

(22) Filed: Mar. 22, 2011

(30) Foreign Application Priority Data
Mar. 23, 2010 (JP) 2010-066494

(51) Int. Cl. H04N 5/225

(52) U.S. Cl. 348/207.1

(57) ABSTRACT

An image capturing system includes an image capturing terminal and an external terminal communicating with the image capturing terminal. Either the image capturing terminal or the external terminal includes a terminal information acquisition unit having a sensor and acquiring the position of the local terminal and the image capturing direction of the image capturing terminal from the sensor; and a calculation unit calculating a relative positional relationship between a subject and the local terminal. The image capturing system includes an instruction unit instructing a correction of the position of the local terminal or the image capturing direction of the image capturing terminal based on calculation result information indicating a calculation result of the relative positional relationship calculated by the calculation unit.

### BACKGROUND OF THE INVENTION

1. Field of the Invention

The present invention relates to an image capturing terminal, an external terminal, an image capturing system, and an image capturing method, which provide information for performing support for the composition determination of a camera.

Priority is claimed on Japanese Patent Application No. 2010-066494, filed Mar. 23, 2010, the content of which is incorporated herein by reference.

2. Description of Related Art

Techniques for taking photographs with a good composition are disclosed in Japanese Unexamined Patent Application, First Publication No. 2002-010114 and Japanese Unexamined Patent Application, First Publication No. 2007-027945.

Japanese Unexamined Patent Application, First Publication No. 2002-010114 discloses a technique of retrieving composition data which is recommended at a point on a local terminal from a recommended composition recording means within the terminal based on information about the position of the terminal as determined by a GPS (Global Positioning System), and displaying the composition data by superimposing it on the a real-time image of a camera. Using this technology, in the case of photographing at a point where composition data exists, it becomes possible to perform photography with good composition regardless of a user's skill.

Japanese Unexamined Patent Application, First Publication No. 2007-027945 discloses a technique of acquiring and displaying a sample image from a dedicated database, based on photographing condition information such as the position information of a local terminal that is determined by a GPS and current date and time information. Using this technique, the sample image for determining the composition may be acquired as needed regardless of time or place and may be referred to for composition determination.

### SUMMARY OF THE INVENTION

According to a first aspect of the present invention, there is provided an image capturing system, which includes an image capturing terminal; and an external terminal communicating with the image capturing terminal. Either the image capturing terminal or the external terminal includes: a terminal information acquisition unit having a sensor detecting a position of a local terminal and an image capturing direction of the image capturing terminal and acquiring the position of the local terminal and the image capturing direction of the image capturing terminal from the sensor; and a calculation unit calculating a relative positional relationship between a subject and the local terminal based on a position of the subject selected based on the position of the local terminal, the position of the local terminal and the image capturing direction of the image capturing terminal. The image capturing terminal includes an instruction unit instructing a correction of the position of the local terminal or the image capturing direction of the image capturing terminal based on a calculation result information indicating a calculation result of the relative positional relationship calculated by the calculation unit.

Preferably, either the image capturing terminal or the external terminal further includes a storage unit storing a subject information including a position of respective subjects; and a selection unit selecting the subject based on the position of the local terminal and the position of the subject included in the subject information. The calculation unit calculates a relative positional relationship between the local terminal and the subject selected in the selection unit based on the position of the subject selected in the selection unit, the position of the local terminal and the image capturing direction of the image capturing terminal.

According to a second aspect of the present invention, there is provided an image capturing terminal included in the image capturing system according to the first aspect of the present invention, which comprises at least the instruction unit.

Preferably; the image capturing terminal further includes the calculation unit.

Preferably, the image capturing terminal further includes the selection unit.

According to a third aspect of the present invention, there is provided an external terminal included in the image capturing system according to the first aspect of the present invention. The external terminal includes at least the terminal information acquisition unit.

Preferably, the external terminal further includes the calculation unit.

According to a fourth aspect of the present invention, there is provided the image capturing system according to the first aspect of the present invention, preferably the instruction unit instructs correction of the position and the image capturing direction of the local terminal or the image capturing terminal according to any one of changes of display, audio, vibration, and weight.

Preferably, the image capturing terminal further includes a correction unit having a driving mechanism that corrects the position or the image capturing direction of the local terminal or the image capturing terminal based on the instruction from the instruction unit.

Preferably, the position of the subject and the position of the local terminal are three-dimensional positions, and the image capturing direction of the image capturing terminal is a direction within a three-dimensional space.

Preferably, the calculation unit calculates the relative positional relationship between the subject and the local terminal at a predetermined time based on the position of the subject that is selected based on the position of the local terminal, the time when the subject exists in the position, and the position and the image capturing direction of the local terminal and the image capturing terminal.

Preferably, the image capturing system further includes a setting unit setting a predetermined time.

Preferably, the terminal information acquisition unit further detects an angle of view from a state of the image capturing unit. The calculation unit further determines whether the subject is outside or inside the angle of view based on the calculation result information. The instruction unit instructs a connection of the position of the image capturing direction of the local terminal only in the case where the subject is outside the angle of view.

According to a fifth aspect of the present invention, there is provided an image capturing method, which includes the steps of acquiring, by a terminal information acquisition unit having a sensor detecting a position and an image capturing direction of a local terminal, the position and the image capturing direction of the local terminal from the sensor; selecting, by a selection unit, a subject from subject information including positions of respective subjects based on the position of the local terminal and the positions of the subjects included in the subject information; calculating, by a calculation unit, a relative positional relationship between the subject and the local terminal based on a position of the selected subject and the position and the image capturing direction of the local terminal; and instructing, by a correction unit, correction of the position or the image capturing direction of the local terminal based on a result of the calculation calculated by the calculation unit.

### BRIEF DESCRIPTION OF THE DRAWINGS

FIG. 1A is a diagram illustrating an outline of an image capturing system according to a first embodiment of the present invention.

FIG. 1B is a diagram illustrating an outline of an image capturing system according to a first embodiment of the present invention.

FIG. 2 is a block diagram illustrating the configuration of an image capturing device according to a first embodiment of the present invention.

FIG. 3 is a flowchart illustrating the working of an image capturing device according to a first embodiment of the present invention.

FIG. 4 is a flowchart illustrating a process of notifying image capturing state change information according to a first embodiment of the present invention.

FIG. 5 is a reference diagram illustrating a subject list according to a first embodiment of the present invention.

FIG. 6A is a diagram illustrating an outline of an image capturing system according to a second embodiment of the present invention.

FIG. 6B is a diagram illustrating an outline of an image capturing system according to a second embodiment of the present invention.

FIG. 6C is a diagram illustrating an outline of an image capturing system according to a second embodiment of the present invention.

FIG. 6D is a diagram illustrating an outline of an image capturing system according to a second embodiment of the present invention.

FIG. 6E is a diagram illustrating an outline of an image capturing system according to a second embodiment of the present invention.

FIG. 7 is a block diagram illustrating the configuration of an image capturing device according to a second embodiment of the present invention.

FIG. 8 is a block diagram illustrating the configuration of a photographing support device according to a second embodiment of the present invention.

FIG. 9 is a flowchart illustrating the working of an image capturing device according to a second embodiment of the present invention.

FIG. 10 is a flowchart illustrating the working of a photographing support device according to a second embodiment of the present invention.

FIG. 11 is a reference diagram illustrating a subject list according to a second embodiment of the present invention.

FIG. 12 is a flowchart illustrating a process of acquiring subject information according to a second embodiment of the present invention.

FIG. 13 is a flowchart illustrating a process of calculating subject position prediction information according to a second embodiment of the present invention.

FIG. 14 is a block diagram illustrating the configuration of an image capturing device according to a modified example of an embodiment of the present invention.

FIG. 15 is a block diagram illustrating the configuration of a photographing support device according to a modified example of an embodiment of the present invention.

FIG. 16 is a block diagram illustrating the configuration of an image capturing device according to a modified example of an embodiment of the present invention.

FIG. 17 is a block diagram illustrating the configuration of an image capturing device according to a modified example of an embodiment of the present invention.

FIG. 18 is a block diagram illustrating the configuration of a photographing support device according to a modified example of an embodiment of the present invention.

FIG. 19 is a diagram illustrating the configuration of an image capturing system according to a modified example of an embodiment of the present invention.

FIG. 20 is a reference diagram illustrating a state of an automatic control according to a modified example of an embodiment of the present invention.

FIG. 21 is a block diagram illustrating the configuration of an image capturing device according to a modified example of an embodiment of the present invention.

### DETAILED DESCRIPTION OF THE INVENTION

Hereinafter, preferred embodiments of the present invention will be described with reference to the accompanying drawings.

### First Embodiment

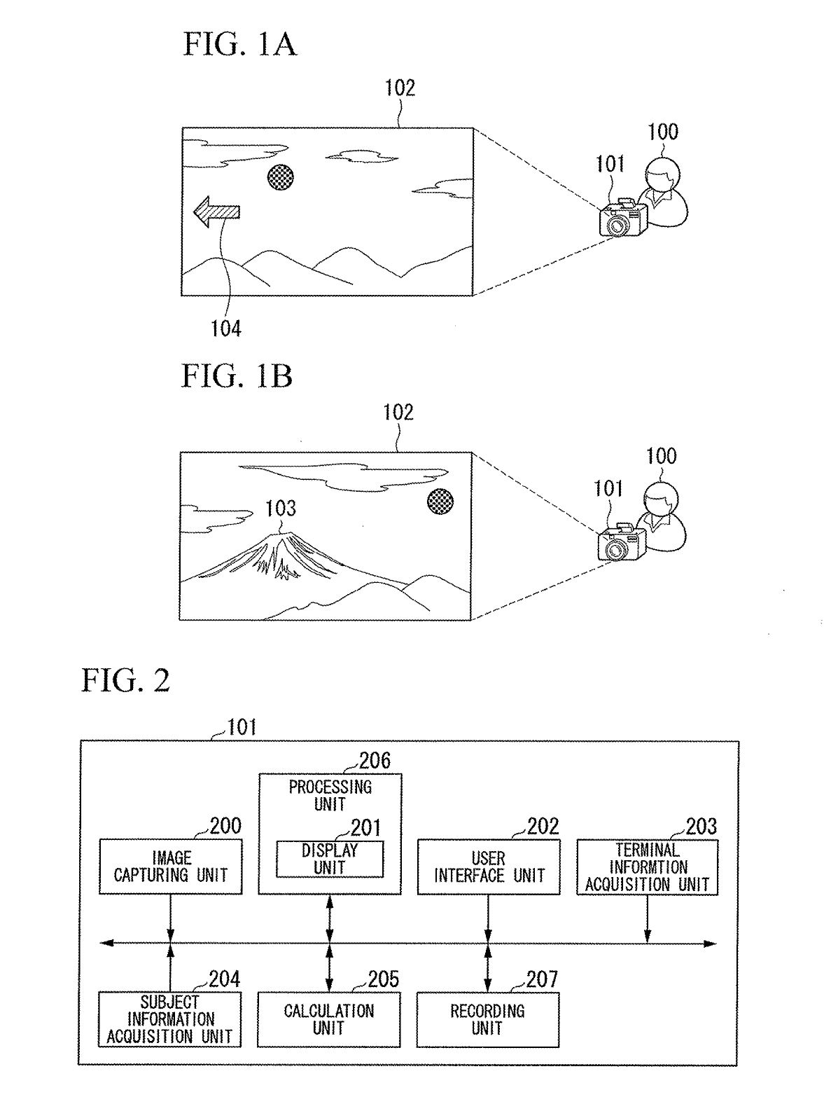

A first embodiment of the present invention will be described. FIGS. 1A and 1B are diagrams illustrating states of image capturing according to a first embodiment of the present invention. An image capturing system according to a first embodiment of the present invention is an example of a system that performs support for displaying a subject, which does not exist in a range of real-time image, in the range of real-time image. In the first embodiment of the present invention, the term “real-time image” is defined as an image that is captured by an image capturing unit, and an image (moving image) sequentially displayed on a display unit.

In examples as illustrated in FIGS. 1A and 1B, a user 100 acquires a real-time image 102 using an image capturing device 101. The image capturing device 101 determines whether or not a subject 103 exists in the range of the real-time image 102. If the subject does not exist in the range of the real-time image 102, the image capturing device 101 notifies the user of the direction in which the subject 103 exists in superimposition with the real-time image 102.

It is sufficient if the subject 103, which is a mountain in the first embodiment of the present invention, is a subject of which the position is calculable, but it is not limited to the mountain. In an example illustrated in FIG. 1A, in the case where the subject does not exist within the range of the real-time image 102 that is acquired by the image capturing device 101, the user 100 is notified of the real-time image 102 in superimposition with an arrow 104 that indicates the direction in which the subject 103 exists.

In an example illustrated in FIG. 1B, the state of the real-time image 102 is indicated in the case where the subject 103 exists within the range of the real-time image 102 that is acquired by the image capturing device 101.

As a method of notifying the user of the direction in which the subject exists, the arrow is displayed as illustrated in FIG. 1A, but the notification method is not limited thereto. For example, diverse notification methods may be used, through flickering of LED, color change of LED, voice guidance, change of the weight, vibration, display of sentences or symbols, and the like.

FIG. 2 shows a block diagram illustrating the configuration of an image capturing device 101 according to a first embodiment of the present invention. The image capturing device 101 as illustrated in FIG. 2 includes an image capturing unit 200, a display unit 201, a user interface unit 202, a terminal information acquisition unit 203, a subject information acquisition unit 204, a calculation unit 205, a processing unit 206, and a recording unit 207.

The image capturing unit 200 captures an image of the subject, and acquired a real-time image. The display unit 201 displays the real-time image acquired by the image capturing unit 200. The display unit 201 notifies the user of the direction in which the subject exists in the case where the subject does not exist within the real-time image. The user interface unit 202 receives a user input such as a start command notification for subject selection or subject-existing directions.

The terminal information acquisition unit 203 acquires position information of the image capturing device 101, direction information that indicates the direction in which the image capturing device 101 is directed, elevation/depression angle information of the image capturing device 101, and angle of view information of the image capturing device 101. More specifically, the terminal information acquisition unit 203 is provided with, for example, a GPS sensor, and acquires the position information of the image capturing device 101 from the GPS sensor. The terminal information acquisition unit 203 is provided with, for example, a direction sensor (geomagnetic sensor), and acquires the direction information from the direction sensor. Also, the terminal information acquisition unit 203 is provided with, for example, an acceleration sensor, and acquires the elevation/depression angle information from the acceleration sensor. Also, the terminal information, acquisition unit 203 acquires the angle of view information by detecting the lens state of the image capturing unit 200. It is also possible to acquire the position information and the direction information of the image capturing device 101 through the GPS sensor and the direction sensor arranged outside the image capturing device 101.

The subject information acquisition unit 204 acquires the position information of the subject. The calculation unit 205 calculates information on the change of the position of the terminal and the change of the image capturing direction that becomes necessary for photographing the subject based on information from the terminal information acquisition unit 203 and the subject information acquisition unit 204, and outputs the calculation result to the processing unit 206. The processing unit 206 controls notification of the direction in which the subject exists based on information from the calculation unit 205. The recording unit 207 records a subject list that lists the subject information, subject-specifying information that specifies a subject that is selected by the user, a real-time image, and the like. The display unit 201 is one that is included in the processing unit 206.

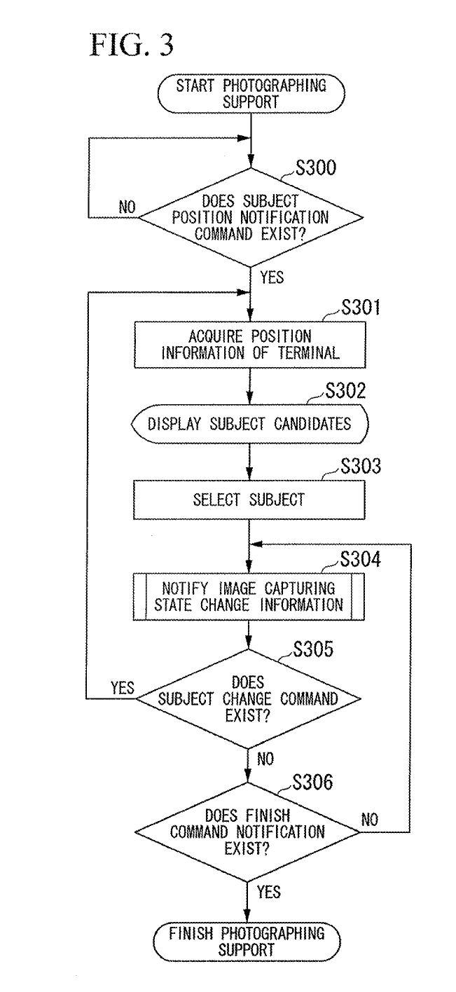

FIG. 3 illustrates the working of an image capturing device 101 according to a first embodiment of the present invention. Hereinafter, the working of the image capturing device 101 according to the first embodiment of the present invention will be described based on FIG. 3.

When a subject position notification command is issued, the image capturing device 101 starts a working of subject position notification (step S300). At this time, in the first embodiment of the present invention, the subject position notification command is issued by user's selection of notification start using the user interface unit 202 or power input to the image capturing device 101. However, the issuance of the subject position notification command is not limited thereto, and may be performed by making a specified impact on the image capturing device 101 or recognizing a specified image. In addition, diverse means may be considered to issue the subject position notification command.

When the subject position notification command is received, the processing unit 206 acquires the position information of the image capturing device 101 from the terminal information acquisition unit 203 (step S301), and notifies the subject information acquisition unit 204 of the acquired position information of the image capturing device 101. The subject information acquisition unit 204 acquires subject candidates, which can be photographed in a position that is indicated by the acquired position information of the image capturing device 101, from the subject list preserved in the recording unit 207, and notifies the processing unit 206 of the acquired subject candidates. For example, the subject information acquisition unit 204 acquires the subject candidates existing in a predetermined distance from the position of the image capturing device 101 from the subject list. The processing unit 206 displays the acquired subject candidates on the display unit 201 (step S302).

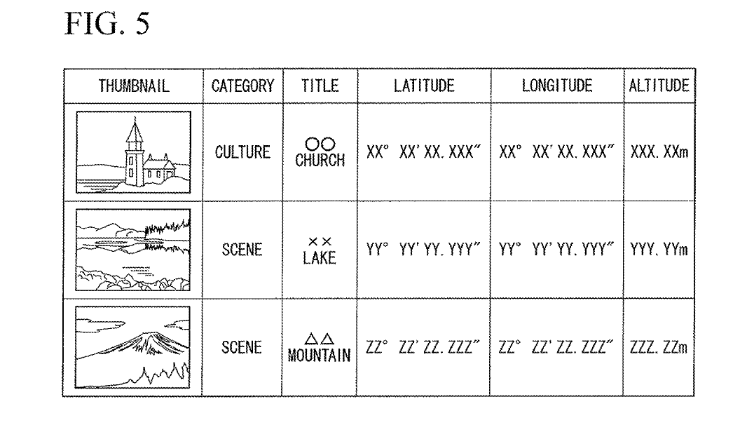

FIG. 5 shows a reference diagram illustrating an example of a subject list according to a first embodiment of the present invention. As illustrated in FIG. 5, in the subject list, various kinds of information of the known subjects (information on thumbnail, category, title, longitude, latitude, an altitude) are related to one another. In the subject list, photographs taken by other users, tag information of the photographs, and the like, may be related to one another, and the related information is not limited to the information as illustrated in FIG. 5.

When the user interface unit 202 receives the user input and the subject is determined, the processing unit 206 records the subject-specifying information that specifies the selected subject in the recording unit 207 (step S303). The subject-specifying information may be any one of information that specifies the subject, such as the position information of the subject, the title of the subject, and the like.

After the recording of the subject-specifying information, the processing unit 206 issues an image capturing state calculation command to the calculation unit 205 in order to acquire the terminal image capturing state change information that indicates the change of the terminal position or the image capturing direction. When the image capturing state calculation command is received, the calculation unit 205 calculates the direction in which the subject exists, and issues the image capturing state change information to the processing unit 206. Here, in the case where the subject exists within a display range of the real-time image, the issued image capturing state change information does not include information that indicates the direction in which the subject exists, while in the case where the subject does not exist within the display range of the real-time image, the image capturing state change information includes the information that indicates the direction in which the subject exists. The processing unit 206 acquires the image capturing state change information from the calculation unit 205, and notifies the user of the direction in which the subject exists (step S304) by displaying an arrow or the like on the display unit 201 according to the image capturing state change information. Accordingly, the user's attention to the change of the position of the image capturing device 101 and the image capturing direction can be attracted. The details of the image capturing state change information notification process as indicated in step S304 will be described in detail later.

After the notification of the image capturing state change information, the processing unit 206 determines whether the subject change command has been issued. In the case where the subject change command has been issued, the processing proceeds to step S301, and the processing unit 206 performs the same process from the selection of the subject. In the case where the subject change command has not been issued, the processing proceeds to step S306 (step S305). In the first embodiment of the present invention, the user's selection of the subject change using the user interface unit 202 is defined as the subject change command.

In the case where the subject change command has not been issued, the processing unit 206 determines whether a finish command notification has been issued from the user interface unit 202. In the case where the finish command notification has been issued, the processing unit 206 finishes the notification of the position information of the subject, while in the case where the subject change command has not been issued, the processing unit 206 performs the process of step S304 again (step S306).

In the first embodiment of the present invention, it is exemplified that the finish command notification is issued through the user's selection of the notification finish using the user interface unit 202 or power cutoff of the image capturing device 101. However, the issuance of the finish command notification is not limited thereto, and may be performed by making a specified impact on the image capturing device 101 or recognizing a specified image. In addition, diverse means may be considered to issue the finish command notification.

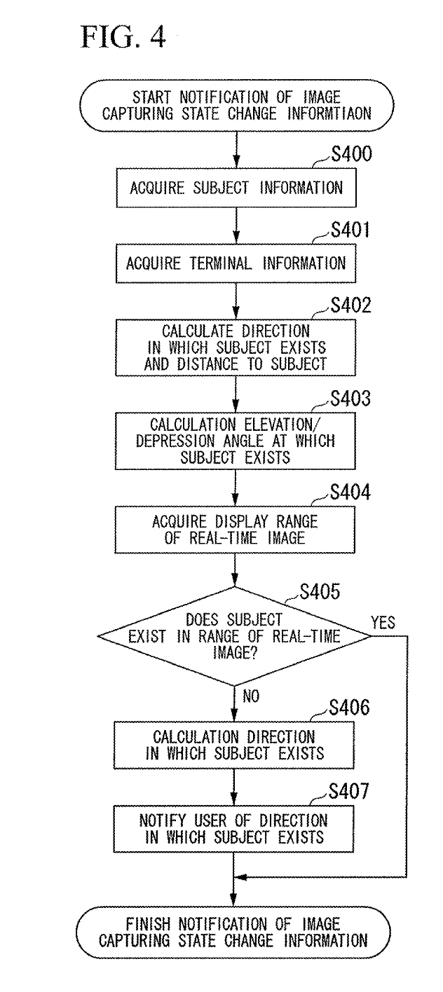

FIG. 4 illustrates the details of a process of notifying image capturing state change information indicated in step S304. When an image capturing state calculation command is received from the processing unit 206, the calculation unit 205 issues a subject request command for requesting the subject information to the subject information acquisition unit 204. When the subject request command is received, the subject information acquisition unit 204 retrieves a subject which coincides with the subject indicated by the subject-specifying information that is recorded in the recording unit 207 from the subject list that is preserved in the recording unit 207. The subject information acquisition unit 204 acquires the position information of the retrieved subject from the subject list, and notifies the calculation unit 205 of the acquired position information (step S400). In the first embodiment of the present invention, the longitude, the latitude, and the altitude, where the subject exists, are defined as the position information of the subject.

After acquiring the position information of the subject, the calculation unit 205 acquires the terminal information of the image capturing device 101 from the terminal information acquisition unit 203 (step S401). In the first embodiment of the present invention, the longitude, the latitude, and the altitude, where the image capturing device 101 exists and the elevation/depression angle, the direction, and the angle of view of the image capturing device 101 are defined as the terminal information of the image capturing device 101.

After acquiring the position information of the image capturing device 101, the calculation unit 205 calculates a distance from the position of the image capturing device 101, which is determined as the origin, to the subject and the direction in which the subject exists based on the longitudes and the latitudes of the image capturing device 101 and the subject (step S402). The calculation unit 205 further calculates the elevation/depression angle of the subject, on the assumption that the position of the image capturing device 101 is determined as the origin, based on the altitudes of the image capturing device 101 and the subject and the distance from the image capturing device 101 to the subject (step S403).

After calculating the direction and the elevation/depression angle in which the subject exists on the assumption that the position of the image capturing device 101 is determined as the origin, the calculation unit 205 calculates a display range of the real-time image that is acquired by the image capturing device 101 from the elevation/depression angle, the direction, and the angle of view of the image capturing device 101 (step S404), and then determines whether the subject exists within the display range of the real-time image (step S405).

In the case where the subject exists within the display range of the real-time image, the calculation unit 205 issues the image capturing state change information that does not include information that indicates the direction in which the subject exists with respect to the processing unit 206, and finishes the image capturing state change information notification process. In the case where the subject does not exist within the display range of the real-time image, the calculation unit 205 calculates the direction in which the subject exists based on the display range of the real-time image, and the elevation/depression angle and the direction in which the subject exists on the assumption that the position of the image capturing device 101 is determined as the origin (step S406).

After calculating the direction in which the subject exists, the calculation unit 205 issues the image capturing state change information including information that indicates the direction in which the subject exists to the processing unit 206. The processing unit 206 displays the direction in which the subject exists on the display unit 701 in superimposition with the real-time image that is acquired by the image capturing device 101 based on the received image capturing state change information, and finishes the image capturing state change information notification process (step S407).

As described above, using the image capturing device 101, the position of a predetermined subject can be specified in any situation. Also, in the case where the subject does not exist within the display range of the real-time image, the direction in which the subject exists is notified, and thus it becomes possible for a user to easily place the subject within the range of the real-time image.

Also, by outputting information on the change of the position of the image capturing device 101 and the change of the image capturing direction that is necessary for image-capturing the subject that is calculated using the terminal information including the position, the elevation/depression angle, the direction, and the angle of view of the image capturing device 101 and the subject information including the position of the subject in diverse methods such as display and the like, the subject position information can be notified. Accordingly, photography with a better composition can be supported.

Also, using three-dimensional positions as the positions of the image capturing device 101 and the subject, the calculation of the elevation/depression angle of the image capturing device 101 can be performed. Because of this, the direction in which the subject exists can be three-dimensionally expressed.

Also, using the angle of view of the image capturing device 101, it can be determined whether the subject exists within the range of the real-time image. Because of this, the direction in which the subject exists can be notified only in the case where the subject does not exist within the range of the real-time image, and thus the load of the process of the image capturing device 101 can be reduced.

Also, according to the image capturing device 101, all processes from the acquisition of the terminal information that is necessary for image-capturing of the subject to the calculation in the direction in which the subject exists can be performed by the local terminal. Because of this, in comparison to the case where a part of the process is performed in other devices, time lag in data exchange between separate terminals can be eliminated.

### Second Embodiment

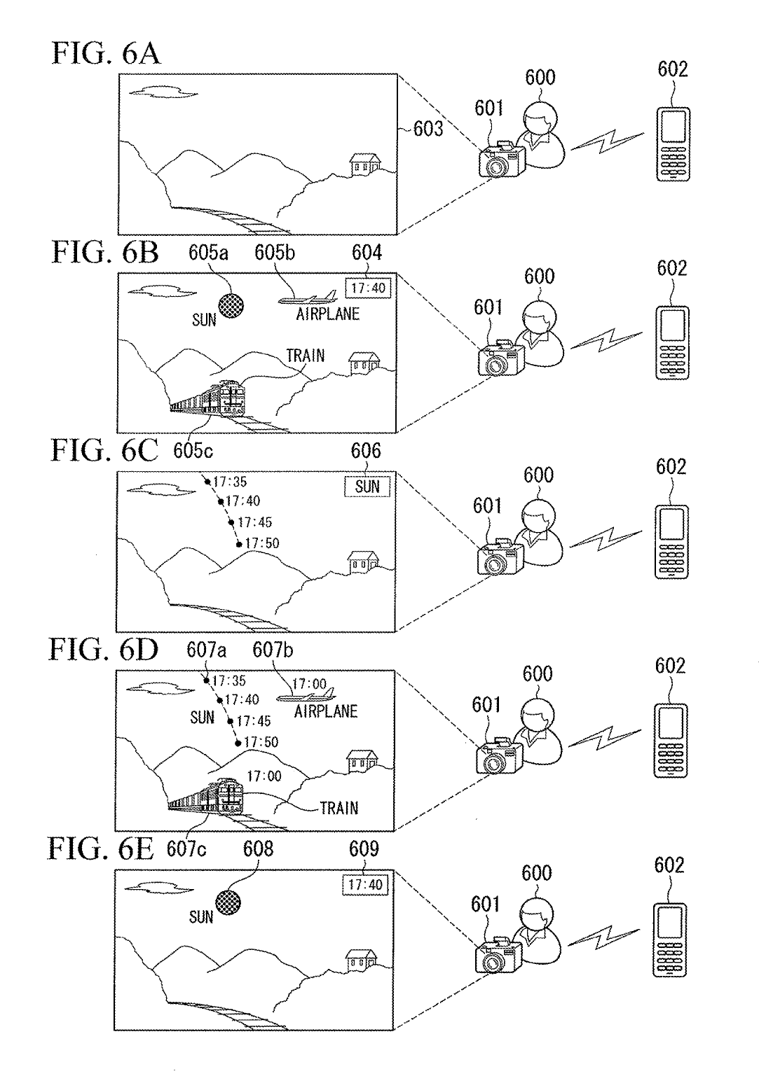

A second embodiment of the present invention will be described. FIGS. 6A to 6E illustrate states of photographing according to a second embodiment of the present invention. An image capturing system according to a second embodiment of the present invention is an example of a system that supports composition determination through prediction of the position of a subject at a predetermined time such as an automatic shooting by predicting the position in which the subjects exists at the predetermined time and displaying the position of the subject by superimposing them on the real-time image.

In an example as illustrated in FIG. 6B, a user 600 who carries a photographing support device 602 acquires a real-time image 603 using an image capturing device 601, and position information that indicates the positions in which subject candidates 605a, 605b, and 605c exist at a predetermined time 604, which is transmitted from the photographing support device 602, is displayed in superimposition with the real-time image. In the second embodiment of the present invention, it is possible to designate a subject 606, predict the time and the position in which the subject 606 exists in the range of the real-time image 603, and display the information in superimposition with the real-time image. Also, in the second embodiment of the present invention, it is possible to predict subjects 607a, 607b, and 607c that will exist in the near future in the range of the real-time image 603 and display the time and the position in which the subjects exist in the range in superimposition with the real-time image 603.

The photographing support device 602 is a communication terminal that can perform radio communication, and is carried by a user 600. In the second embodiment of the present invention, it is assumed that the photographing support device 602 is a mobile phone. However, it is sufficient if the photographing support device 602 is a communication terminal that can perform radio communication, and is not specially limited to the mobile phone.

The subject candidates 605a, 605b, and 605c are subject candidates that can predict the positions at a predetermined time 604, and in the second embodiment of the present invention, the subject candidates are the sun, an airplane, and a train, respectively. It is sufficient if these subject candidates are subjects that can predict the positions at the predetermined time, and are not specifically limited to the above-described subjects.

The subject 606 is a subject that can predict the position at the predetermined time, and in the second embodiment of the present invention, the subject is the sun. However, it is sufficient if the subject is a subject that can predict the position at the predetermined time, and is not specifically limited to the sun.

The subjects 607a, 607b, and 607c are subjects that will exist in the range of the real-time image 603 in the near future, and in the second embodiment of the present invention, the subjects are the sun, an airplane, and a train, respectively. It is sufficient if these subjects are subjects that will exist in the range of the real-time image 603 in the near future, and are not specifically limited to the above-described subjects.

In an example as illustrated in FIG. 6A, the user 600 who carries the photographing support device 602 acquires the real-time image 603 using the image capturing device 601. In an example as illustrated in FIG. 6B, the position information of the subject candidates at the predetermined time 604 is calculated, and the subject candidates 605a, 605b, and 605c in the range of the real-time image 603 are displayed in superimposition with the real-time image 603.

In an example as illustrated in FIG. 6C, the time and the position information in which the predetermined subject 606 exists in the range of the real-time image 603 are calculated, and are displayed in superimposition with the real-time image 603. In an example as illustrated in FIG. 6D, the time and the position information of the subject candidates that are predicted to exist in the range of the real-time image 603 in the near future, which exist in the range of the real-time image, are calculated and displayed in superimposition with the real-time image 603. In an example of FIG. 6E, the position information in which a predetermined subject 608 exists at a predetermined time 609 is calculated and if the subject 608 exists within the range of the real-time image 603 at the predetermined time 609, the position information is displayed in superimposition with the real-time image 603.

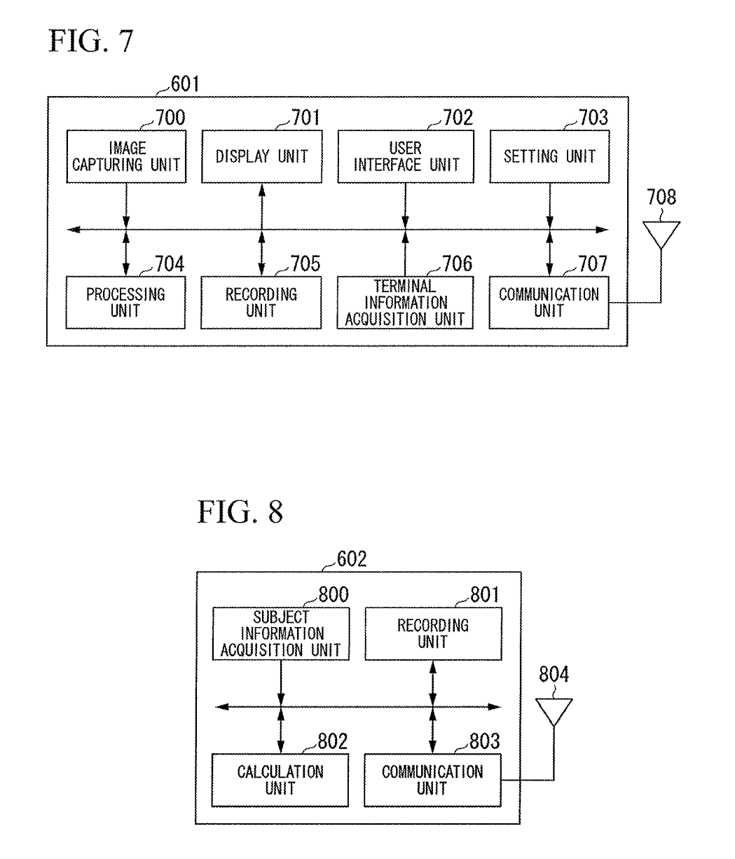

FIG. 7 is a block diagram illustrating the configuration of an image capturing device 601 according to a second embodiment of the present invention. The configuration of the image capturing device 601 will be described based on FIG. 7. The image capturing device 601 as illustrated in FIG. 7 includes an image capturing unit 700, a display unit 701, a user interface unit 702, a setting unit 703, a processing unit 704, a recording unit 705, a terminal information acquisition unit 706, a communication unit 707, and an antenna 708.

The image capturing unit 700 captures an image of the subject, and acquired a real-time image. The display unit 701 displays the real-time image acquired by the image capturing unit 700. Also, the display unit 701 displays the positions of subject candidates existing within the range of the real-time image at a predetermined time, the position and the time in which a specified subject exists within the range of the real-time image, or subject position prediction information that indicates the position and the time of a subject that will exist within the real-time image in the near future, all of which are output from the processing unit 704, together with the real-time image. The user interface unit 702 receives an input of start, finish, and the like, of the position prediction of the subject from the user.

The setting unit 703 automatically sets a prediction time or a subject that is the subject of prediction. The processing unit 704 performs control to output subject position prediction information acquired by the photographing support device 602 and time information that is set by the setting unit 703 to the display unit 701. The recording unit 705 records the real-time image and the like. The terminal information acquisition unit 706 acquires position information of the image capturing device 601, direction information that indicates the direction in which the image capturing device 601 is directed, elevation/depression angle information of the image capturing device 601, and angle of view information of the image capturing device 601. The method of acquiring the information is in the same manner as that according to the first embodiment. The communication unit 707 performs radio communication with an external communication device that includes the photographing support device 602. The antenna 708 performs transmission/reception of radio waves for the radio communication.

FIG. 8 illustrates the configuration of the photographing support device 602 according to the second embodiment of the present invention. The configuration of the photographing support device 602 will be described based on the drawings. The photographing support device 602 as illustrated in FIG. 8 includes a subject information acquisition unit 800, a recording unit 801, a calculation unit 802, a communication unit 803, and an antenna 804.

The subject information acquisition unit 800 acquires the subject information that is necessary to calculate the position information of a subject at a predetermined time from the recording unit 801. The recording unit 801 records a subject list that includes subject information. The calculation unit 802 calculates subject position prediction information from the terminal information that specifies the position, direction, elevation/depression angle, and the angle of view of the image capturing device 601, which are acquired from the image capturing device 601, and the subject information. The communication unit 803 performs radio communication with an external communication device that includes the image capturing device 601. The antenna 804 performs transmission/reception radio waves for the radio communication.

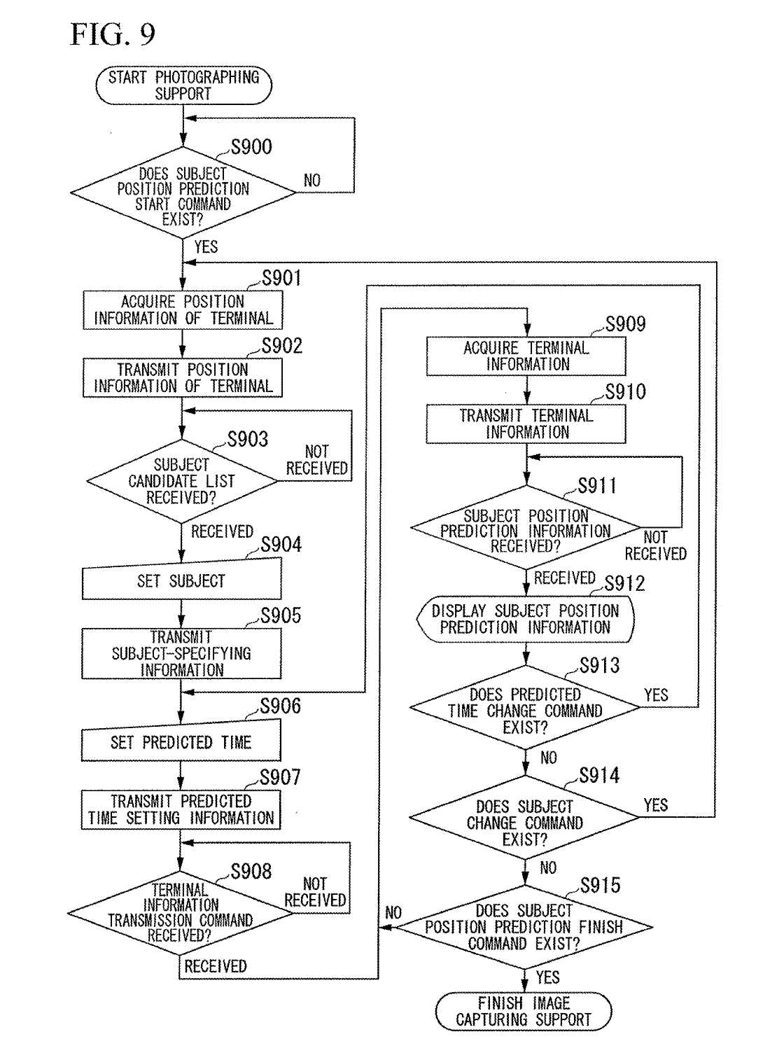

FIG. 9 illustrates the working of an image capturing device 601 according to a second embodiment of the present invention. The working of the image capturing device 601 will be described based on FIG. 9.

When a subject position prediction start command that is a command for starting a photographing support calculation that predicts the position of a subject is issued, the image capturing device 601 starts a subject position prediction calculation (step S900).

In the second embodiment of the present invention, the subject position prediction command is issued by power input to the image capturing device 601, but the issuance of the subject position prediction command is not limited thereto. The subject position prediction command may be issued by making a specified impact on the image capturing device 101, recognizing a specified image, or selecting the start of the subject position prediction by a user using the user interface unit 702. In addition, diverse means may be considered to issue the subject position prediction command.

When the subject position prediction command is issued, the processing unit 704 acquires the position information of the local terminal from the terminal information acquisition unit 706 (step S901), and transmits the position information to the photographing support device 602 via the communication unit 707 and the antenna 708 (step S902). The processing unit 704 transmits the position information to the photographing support device 602, and then receives a subject candidate list listing photographable subjects which can be photographed in the position of the image capturing device 601 from the photographing support device 602 via the communication unit 707 and the antenna 708 (step S903). When the subject candidate list is acquired, the processing unit 704 displays the subject candidate list on the display unit 701.

When the subject is selected by the user using the user interface unit 702 (step S904), the processing unit 704 transmits the subject-specifying information that specifies the selected subject to the photographing support device 602 via the communication unit 707 and the antenna 708 (step S905). In the second embodiment of the present invention, there is a case where the subject is not specified. In this case, the subject-specifying information that does not include information that specifies the subject is transmitted to the photographing support device 602.

When the predicted time setting information that specifies the time at which the position in which the subject exists is predicted is set by the user using the user interface unit 702 after the subject-specifying information is transmitted (step S906), the processing unit 704 transmits the predicted time setting information to the photographing support device 602 via the communication unit 707 and the antenna 708 (step S907). In the second embodiment of the present invention, there is a case where the predicted time is not set. In this case, the processing unit 704 transmits the predicted time setting information that does not include the information that specifies the predicted time to the photographing support device 602. Although in the second embodiment of the present invention, the predicted time is set by the user using the user interface unit 702, the setting of the predicted time may be automatically performed by the setting unit 703 according to the subject, and may not be limited to the setting by the user.

When a terminal information transmission command is received from the photographing support device 602 via the communication unit 707 and the antenna 708 (step S908), the processing unit 704 acquires the terminal information from the terminal information acquisition unit 706 (step S909), and transmits the terminal information to the photographing support device 602 via the communication unit 707 and the antenna 708 (step S910). In the second embodiment of the present invention, the position, elevation/depression angle, direction, and angle of view information of the image capturing device 601 may be considered as the terminal information.

At the predicted time that is specified by the predicted time setting information after the terminal information is transmitted to the photographing support device 602, the processing unit 704 receives the subject position prediction information that indicates the position in which the subject that is specified by the subject-specifying information exists from the photographing support device 602 via the communication unit 707 and the antenna 708 (step S911). After receiving the subject position prediction information, the processing unit 704 displays the subject position prediction information on the display unit 701 in superimposition of the real-time image that is acquired by the image capturing device 601 (step S912). The subject position prediction information includes position information of the subject within the real-time image at a predetermined time. In the case where the subject exists in the real-time image, the subjects (subject candidates 605a, 605b, and 605c in FIG. 6B, the subject 606 in FIG. 6C, and the subjects 607a, 607b, and 607c in FIG. 6D) are displayed in the positions within the image that is indicated by the position information.

After displaying the subject position prediction information, the processing unit 704 determines whether a predicted time change command that is a command for changing the time to be predicted has been issued. If the predicted time change command has been issued, the processing unit 704 proceeds to the processing in step S906, and performs the process again from the setting of the predicted time (step S913).

If the predicted time change command has not been issued, the processing unit 704 determines whether a subject change command for changing the subject that is the subject of position prediction has been issued. If the subject change command has been issued, the processing unit 704 proceeds to the processing in step S901, and performs the process again from the acquisition of the position information of the image capturing device 601 (step S914).

If the subject change command has not been issued, the processing unit 704 determines whether the subject position prediction finish command that is a command for finishing the photographing support that predicts the position of the subject has been issued. If the subject position prediction finish command has not been issued, the processing unit 704 proceeds to the processing in step S909, and performs the process again from the acquisition of the terminal information. If the subject change command has been issued, the processing unit 704 finishes the subject position prediction calculation (step S915).

In the second embodiment of the present invention, it is exemplified that the subject position prediction finish command is issued through the power cutoff of the image capturing device 601. However, the issuance of the subject position prediction finish command is not limited thereto, and may be performed by making a specified impact on the image capturing device 101, recognizing a specified image, or selecting the finish of the subject position prediction by the user using the user interface unit 702. In addition, diverse means may be considered to issue the subject position prediction finish command.

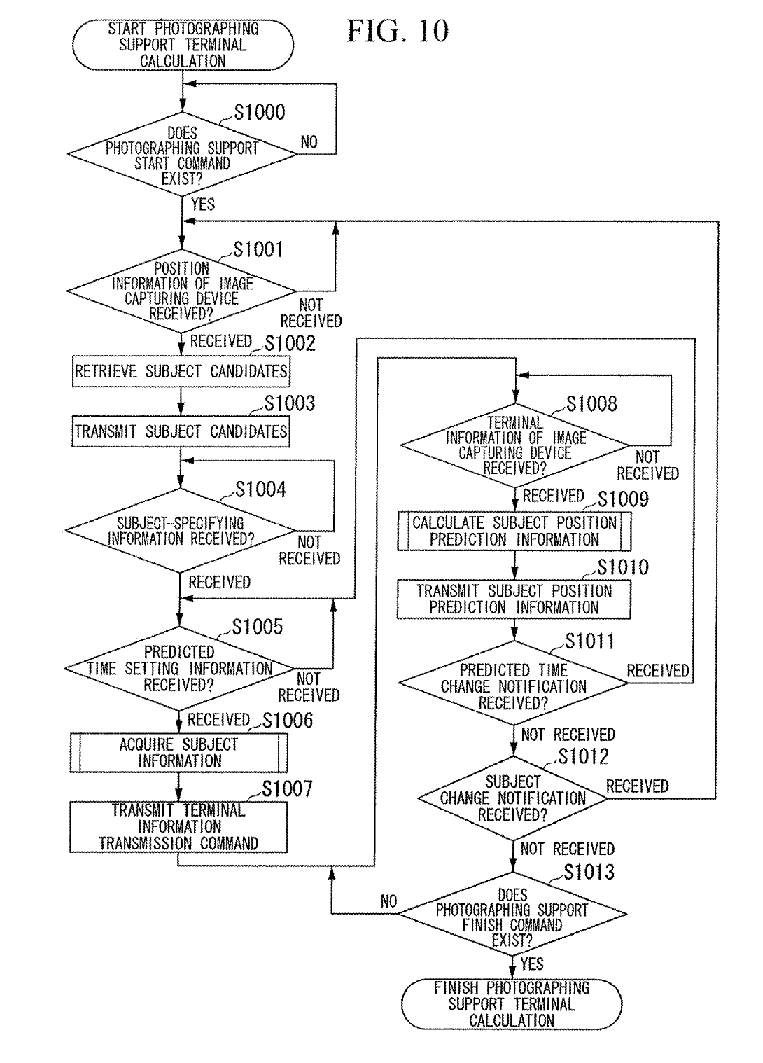

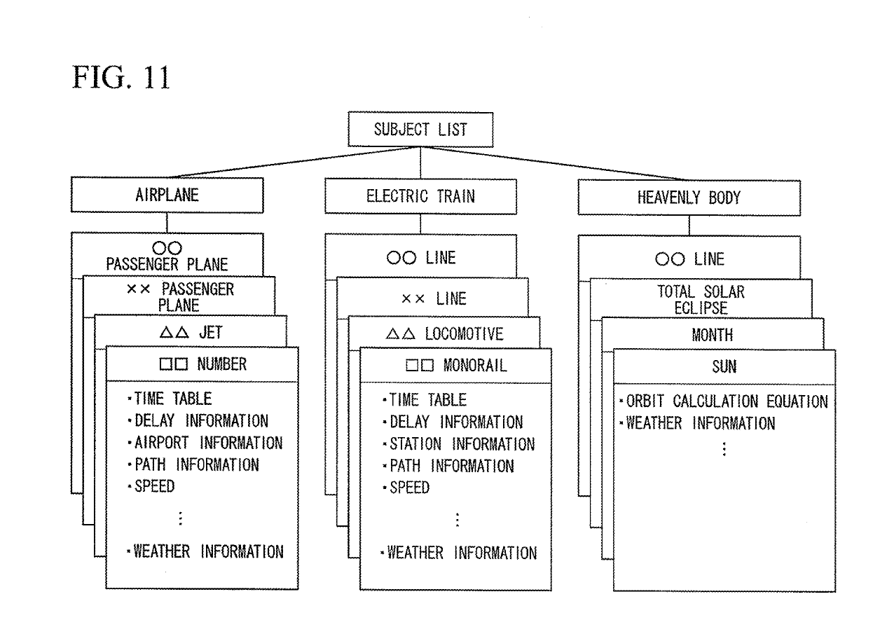

FIG. 10 illustrates the working of the photographing support device 602 according to the second embodiment of the present invention. The working of the photographing support device 602 will be described based on FIG. 10.

When a photographing support start command that is a command for starting the working of providing subject position prediction information as indicated in step S911 to the image capturing device 601 is received, the photographing support device 602 starts the providing of the subject position prediction information (step S1000). In the second embodiment of the present invention, it is exemplified that the photographing support start command is issued through the power input to the photographing support device 602. However, the issuance of the photographing support start command is not limited thereto, and may be performed by making a specified impact on the photographing support device 602, or issuing the photographing support state command through the reception of the specified information from the image capturing device 601. In addition, diverse means may be considered to issue the photographing support start command.

When the photographing support device 602 that has received the photographing support start command starts the working, the calculation unit 802 receives the position information of the image capturing device 601 that is transmitted from the image capturing device 601 via the communication unit 803 and the antenna 804 (step S1001). The calculation unit 802 retrieves the subject candidates existing in the neighborhood of the image capturing device 601 from the subject list that is recorded in the recording unit 801 based on the position information of the image capturing device 601 (step S1002). By this retrieval, for example, the subject candidates existing within a predetermined distance from the position of the image capturing device 601 are extracted from the subject list. The calculation unit 802 transmits the subject candidate list that is a list of the subject candidates extracted by the retrieval to the image capturing device 601 via the communication unit 803 and the antenna 804 (step S1003).

FIG. 11 illustrates an example of a subject list according to a second embodiment of the present invention. As illustrated in FIG. 11, the subject list is first classified by categories, and then is classified again by inherent subjects. It is exemplified that in the subject list, subject information (information on a moving path, an orbit, time at an intermediate point, and the like) for predicting the position of the subject at the predetermined time is related to the respective subjects, but the present invention is not limited thereto.

After transmitting the subject candidate list to the image capturing device 601, the calculation unit 802 receives the subject-specifying information that specifies the selected subject from the image capturing device 601 via the communication unit 803 and the antenna 804 (step S1004). After acquiring the subject-specifying information, the calculation unit 802 receives the predicted time setting information set by the image capturing device 601 via the communication unit 803 and the antenna 804 (step S1005).

After acquiring the predicted time setting information, the calculation unit 802 acquires the subject information in accordance with the subject-specifying information, the predicted time setting information, and information on the subject candidate list (step S1006). The processing in step S1006 will be described later.

After acquiring the subject information, the calculation unit 802 transmits the terminal information transmission command that is a command for acquiring the terminal information from the image capturing device 601 to the image capturing device 601 via the communication unit 803 and the antenna 804 (step S1007). Thereafter, the calculation unit 802 receives the terminal information transmitted from the image capturing device 601 (step S1008).

After acquiring the terminal information, the calculation unit 802 calculates the subject position prediction information based on the terminal information, the subject information and predicted time setting information (step S1009). The subject position prediction information calculation process indicated in step S1009 will be described later. The calculation unit 802 transmits the calculated subject position prediction information to the image capturing device 601 via the communication unit 803 and the antenna 804 (step S1010).

After transmitting the subject position prediction information to the image capturing device 601, the calculation unit 802 determines whether a prediction time change notification that is a command for changing the time at which the position of the subject is predicted has been received from the image capturing device 601. In the case where the calculation unit 802 has received the predicted time change notification, the calculation unit 802 performs the process again from the reception of the predicted time setting information indicated in step S1005 (step S1011).

In the case where the calculation unit 802 has not received the predicted time change notification, the calculation unit 802 determines whether the subject change notification that is a command for changing the subject that is the subject of position prediction has been received. In the case where the calculation unit 802 has received the subject change notification, the calculation unit 802 performs the process again from the acquisition of the position information through the image capturing device 601 that is indicated in step S1001 (step S1012).

In the case where the calculation unit 802 has not received the subject change notification, the calculation unit 802 determines whether a photographing support finish command, which is a command for finishing the operation that provides the subject position prediction information to the image capturing device 601, has been issued. If the photographing support finish command has not been issued, the calculation unit 802 performs the process again from the acquisition of the terminal information of the image capturing device that is indicated in step S1008. If the photographing support finish command has been issued, the calculation unit 802 finishes the providing of the subject position prediction information (step S1013).

in the second embodiment of the present invention, it is exemplified that the photographing support finish command is issued through the power cutoff of the photographing support device 602. However, the issuance of the photographing support finish command is not limited thereto, and may be performed by making a specified impact on the image capturing device 601 or receiving specified information from the image capturing device 601. In addition, diverse means may be considered to issue the photographing support finish command.

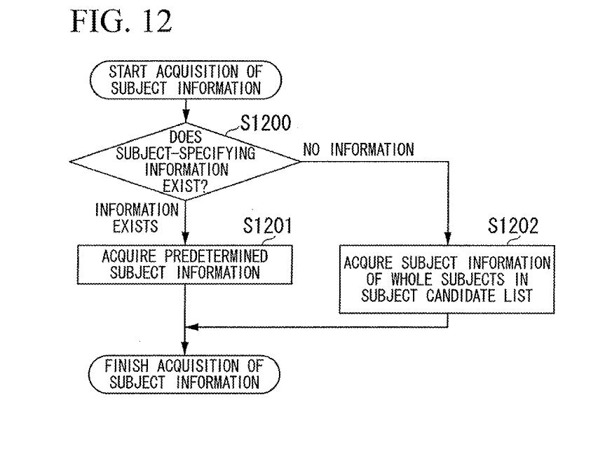

FIG. 12 illustrates the details of the subject information acquisition process that is indicated in step S1006. The calculation unit 802 determines whether information that specifies the subject is included in the subject-specifying information received from the image capturing device 601 (step S1200). If the information that specifies the subject is included, the calculation unit 802 acquires the subject information of the specified subject (step S1201). If the information that specifies the subject is not included, the calculation unit 802 acquires the subject information of the whole subjects in the subject candidate list (step S1202).

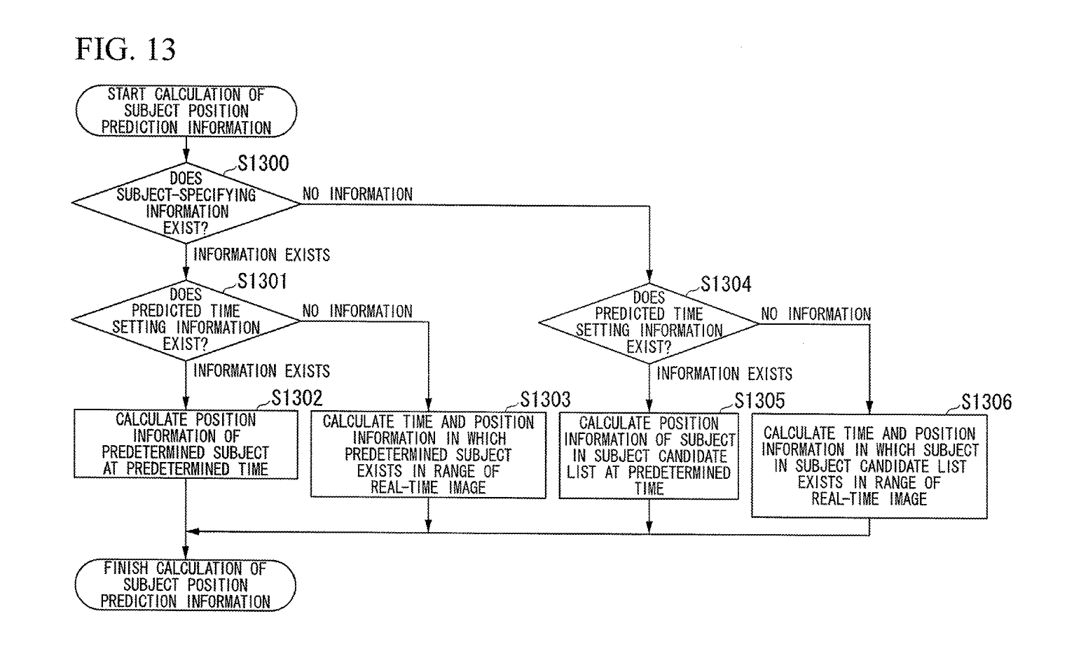

FIG. 13 illustrates the details of the subject position prediction information calculation process that is indicated in step S1009. The calculation unit 802 determines whether information that specifies the subject is included in the subject-specifying information received from the image capturing device 601. If the information that specifies the subject is included, the calculation unit 802 proceeds to the processing that is indicated in step S1301. If the information that specifies the subject is not included, the calculation unit 802 proceeds to the processing that is indicated in step S1304 (step S1300).

In step S1300, if it is determined that the information that specifies the subject is included in the subject-specifying information, the calculation unit 802 determines whether the information that specifies the predicted time is included in the predicted time setting information received from the image capturing device 601 (step S1301). If the information that specifies the predicted time is included, the calculation unit 802 performs the calculation of the position information in which a predetermined subject exists at a predetermined time, and records the position information of the subject that exists within the real-time image at the predetermined time in the recording unit 801 (step S1302).

More specifically, the calculation unit 802 performs the calculation of the position information of the subject at a predicted time based on the subject information acquired in step S1201. Also, the calculation unit 802 performs the calculation such as in steps S402 to S404 in the first embodiment of the present invention based on the position information of the subject at the predicted time. Also, the calculation unit 802 calculates the position of the subject on the real-time image based on the display range on the real-time image in the image-capturing direction of the image capturing device 601 and the elevation/depression angle and the direction in which the subject exists if it is assumed that the position of the image capturing device 601 is the origin, and generates the subject position prediction information that includes the position information within the real-time image of the subject at the predicted time. The information calculated in step S1302 corresponds to the information indicated in. FIG. 6E.

In step S1301, if the information that specifies the predicted time is not included, the calculation unit 802 performs the calculation of the time and the position information in which the predetermined subject exists within the range of the real-time image, and records the position information of the subject existing within the real-time image and the time information in the recording unit 801 (step S1303).

More specifically, the calculation unit 802 performs the calculation of the position information of the subject at plural times based on the subject information acquired in step S1201. Also, the calculation unit 802 performs the calculation such as in steps S402 to S404 in the first embodiment of the present invention based on the position information of the subject at the respective times. Also, the calculation unit 802 calculates the position of the subject on the real-time image at the respective times based on the display range on the real-time image in the image-capturing direction of the image capturing device 601 and the elevation/depression angle and the direction in which the subject exists at the respective times if it is assumed that the position of the image capturing device 601 is the origin, and generates the subject position prediction information that includes the position information within the real-time image of the subject at the respective times. In this case, the information calculated in step S1303 corresponds to the information indicated in FIG. 6C.

In step S1300, if it is determined that the information that specifies the subject is not included in the subject-specifying information, the calculation unit 802 determines whether the information that specifies the predicted time is included in the predicted time setting information received from the image capturing device 601 (step S1304). If the information that specifies the predicted time is included in the predicted time setting information, the calculation unit 802 performs the calculation of the position information in which the subject in the subject candidate list exists at the predetermined time, and records the position information of the subject that exists within the real-time image at the predetermined time in the recording unit 801 (step S1305).

More specifically, the calculation unit 802 performs the calculation of the position information of the respective subjects at the predicted time based on the subject information acquired in step S1202. Also, the calculation unit 802 performs the calculation such as in steps S402 to S404 in the first embodiment of the present invention based on the position information of the respective subjects at the predicted time. Also, the calculation unit 802 calculates the positions of the respective subjects on the real-time image based on the display range on the real-time image in the image-capturing direction of the image capturing device 601 and the elevation/depression angle and the direction in which the respective subjects exist if it is assumed that the position of the image capturing device 601 is the origin, and generates the subject position prediction information that includes the position information within the real-time image of the subject at the predicted time. The information calculated in step S1305 corresponds to the information indicated in FIG. 6B.

In step S1304, if the information that specifies the predicted time is not included in the predicted time setting information, the calculation unit 802 performs the calculation of the time and the position information in which the subject in the subject candidate list exists within the range of the real-time image, and records the position information of the subject that exists within the real-time image and the time information in the recording unit 801 (step S1306).

More specifically, the calculation unit 802 performs the calculation of the position information of the respective subjects at plural times based on the subject information acquired in step S1202. Also, the calculation unit 802 performs the calculation such as in steps S402 to S404 in the first embodiment of the present invention based on the position information of the respective subjects at the respective times. Also, the calculation unit 802 calculates the positions of the respective subjects on the real-time image at the respective times based on the display range on the real-time image in the image-capturing direction of the image capturing device 601 and the elevation/depression angle and the direction in which the respective subjects exist at the respective times if it is assumed that the position of the image capturing device 601 is the origin, and generates the subject position prediction information that includes the position information within the real-time image of the respective subjects at the respective times. The information calculated in step S1306 corresponds to the information indicated in FIG. 6D.

As described above, by using the image capturing device 601 and the photographing support device 602, the position information in which the predetermined subject exists at the predetermined time can be displayed in superimposition with the real-time image. Because of this, even in the case of performing the automatic shooting that requires preparation of a camera through prediction of the position in which the predetermined subject exists at the predetermined time, which is representative as the photographing using a timer, the composition determination can be easily performed.

Also, the position in which the subject exists can be calculated for each time. Because of this, the position information of the subject having higher precision can be calculated.

Also, making use of the angle of view of the image capturing device 601, it can be determined whether the subject exists within the range of the real-time image. Because of this, in the case where the subject exists within the range of the real-time image and in the case where the subject does not exist within the range of the real-time image, the following processing method may be changed.

Also, since the image capturing device 601 can perform the acquisition of the subject information using the communication, it is not necessary to install the subject information acquisition unit in the image capturing device 601. Accordingly, the processing load can be reduced to the extent that the load becomes unnecessary when the subject information is acquired.

Also, the image capturing device 601 can acquire the subject position prediction information that is calculated by the calculation unit installed on the photographing support device 602. Because of this, the processing of the image capturing device 601 can be performed by performing the display control through the processing unit 704 and the communication control by the communication unit 707. Accordingly, the processing load of the image capturing device 601 can be reduced.

### [Modifications]

Although the embodiments of the present invention have been described as above, the present invention is not limited to the above-described two embodiments.

For example, in the first embodiment of the present invention, the calculation of the image capturing state change information may be performed by the external photographing support device 602 as in the second embodiment of the present invention, and the image capturing state change information may be received from the photographing support device 602. Also, in the second embodiment of the present invention, all calculations of the subject position prediction information may be performed by the image capturing device 601. Although the subject information is acquired by the subject information acquisition unit in both the first and second embodiments, the subject information may be received from the external providing server using the communication unit. As described above, the configurations are not limited to those in the two embodiments as described above unless they depart from the scope of the invention.

Also, for example, in the case where the subject is confirmed as shown in FIG. 6E in the second embodiment of the present invention, the notification method according to the first embodiment of the present invention may be used. That is, in the second embodiment of the present invention, if the position information of the subject at a predetermined time does not exist within the range of the real-time image, the direction in which the subject exists may be displayed in superimposition with the real-time image, while if the position information of the subject at a predetermined time exists within the range of the real-time image, the place or the direction may be displayed in superimposition with the real-time image. As described above, the configurations are not limited to those in the two embodiments as described above unless they depart from the scope of the invention.

Also, for example, in the second embodiment of the present invention, the photographing support device 602 may be configured as an external server that provides the information, and a billing system may be installed so that when the image capturing device acquires the information by accessing the external server, the user pays the price with respect to the manager of the external server.

Also, for example, in the second embodiment of the present invention, the terminal information acquisition unit is a block that provides the position information, the direction information, and the elevation/depression angle information. However, if the distance between the image capturing device and the photographing support device is sufficiently short, the terminal information acquisition unit may be divided into three blocks of a position information acquisition unit, a direction information acquisition unit, and an elevation/depression angle information acquisition unit, so that the direction information acquisition unit and the elevation/depression angle information acquisition unit are installed in the image capturing device 601, and the position information acquisition unit is installed in the accompanying photographing support device 602.

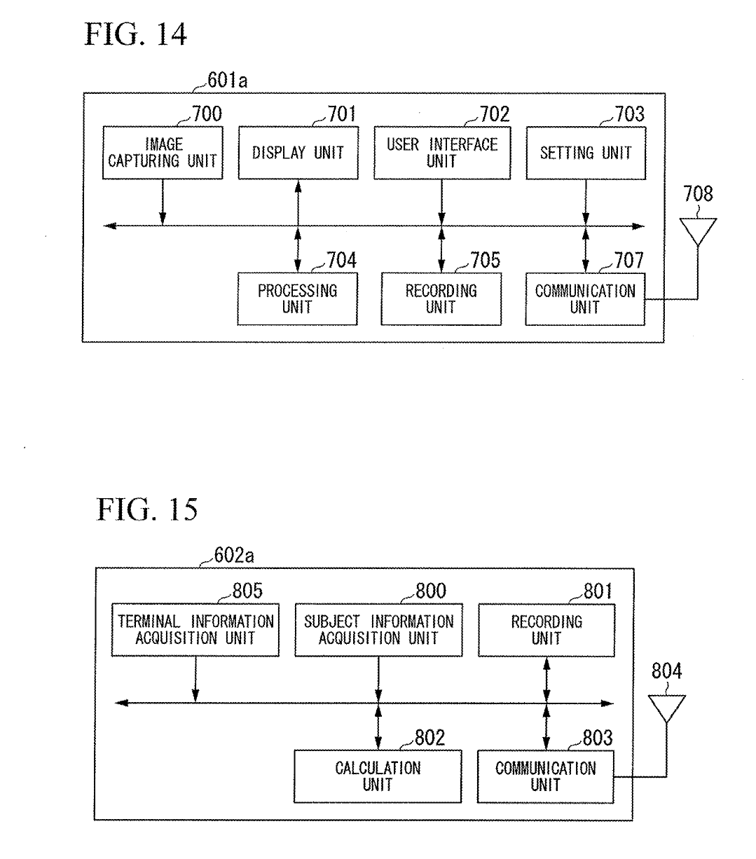

Also, in the second embodiment of the present invention, if the distance between the image capturing device and the photographing support device is sufficiently short, the image capturing device and the photographing support device may be configured as the configurations as illustrated in FIGS. 14 and 15. In the image capturing device 601a illustrated in FIG. 14, the terminal information acquisition unit 706 in the image capturing device 601 as illustrated in FIG. 7 is not installed. In the photographing support device 602a illustrated in FIG. 15, the terminal information acquisition unit 805 is added to the configuration of the photographing support device 602 illustrated in FIG. 8.

Under the circumstances where the user carries the image capturing device 601a and the photographing support device 602a, the terminal information acquisition unit 805 acquires the terminal information of the image capturing device 601a. The calculation unit 802 performs the calculation of the above-described subject position prediction information.

Also, with respect to FIGS. 14 and 15, the followings may be performed. The communication unit 803 transmits the terminal information acquired by the terminal information acquisition unit 805 to the image capturing device 601a. In the image capturing device 601a, the communication unit 707 receives the terminal information. The received terminal information is recorded in the recording unit 705. Also, in the photographing support device 602a, the subject information acquisition unit 800 reads the subject list recorded in the recording unit 801, and selects a subject that is near to the position of the image capturing device 601a. The communication unit 803 transmits the subject information of the selected subject to the image capturing device 601a. In the image capturing device 601a, the communication unit 707 receives the subject information. The received subject information is recorded in the recording unit 705. The processing unit 704 reads the terminal information and the subject information from the recording unit 705, and performs the calculation of the above-described subject position prediction information.

Also, in the second embodiment of the present invention, the acquisition of the subject information may be performed by the image capturing device 601. That is, the communication unit 803 of the photographing support device 602 transmits the subject list read from the recording unit 801 to the image capturing device 601. The communication unit 707 of the image capturing device 601 receives the subject list. The received subject list is recorded in the recording unit 705. The processing unit 704 reads the subject list from the recording unit 705, selects a subject that is near to the position of the image capturing device 601, and performs the calculation of the above-described subject position prediction information based on the subject information of the subject selected by the user using the user interface unit 702 among the subjects.

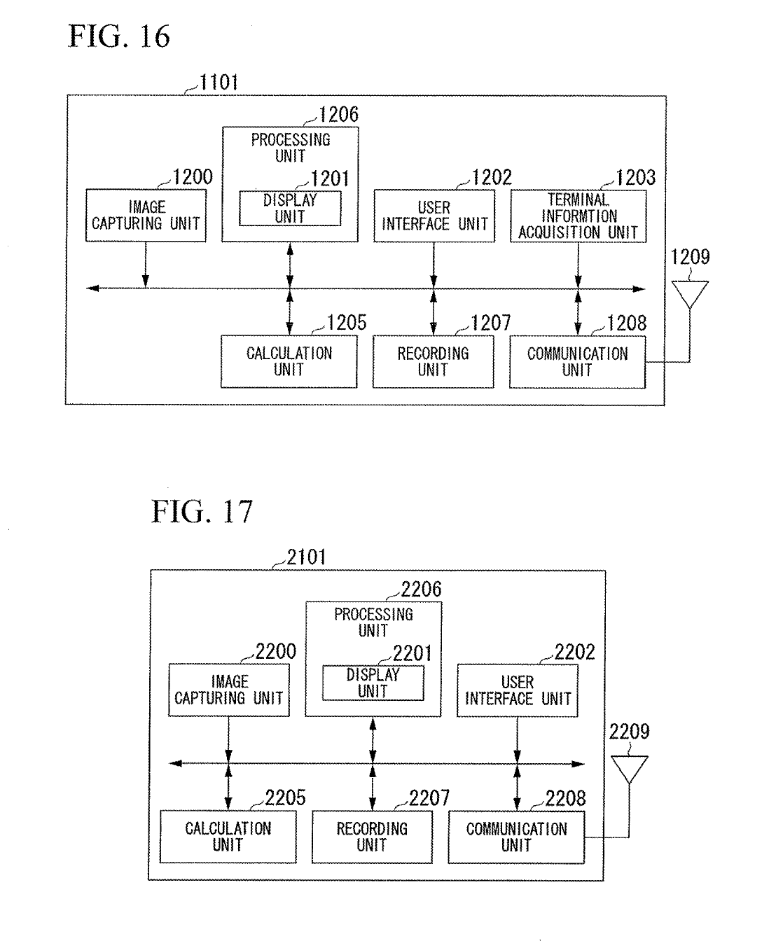

Also, in the first embodiment of the present invention, the image capturing device may be configured to use the photographing support device as in the second embodiment of the present invention. FIG. 16 illustrates an image capturing device 1101 that is a modification of the image capturing device 101 according to the first embodiment of the present invention.

In the image capturing device 1101 illustrated in FIG. 16, the subject information acquisition unit 204 in the image capturing device 101 illustrated in FIG. 2 is not installed. The image capturing device 1101 is additionally provided with a communication unit 1208 and an antenna 1209.

In the modification illustrated in FIG. 16, the terminal information, such as the position information of the image capturing device 1101, the direction information, the elevation/depression angle information, the angle of view information, and the like, which are acquired by the terminal information acquisition unit 1203 illustrated in FIG. 16, is transmitted by the communication unit 1208, for example, to the photographing support device 602 illustrated in FIG. 8 through the antenna 1209. The photographing support device 602, which has acquired the terminal information transmitted from the image capturing device 1101, in the same manner as in the second embodiment, transmits the subject candidate list to the image capturing device 1101 via the communication unit 803 and the antenna 804. The subject candidate list transmitted from the photographing support device 602 is received by the communication unit 1208 through the antenna 1209. The subject candidate list received by the communication unit 1208 is sent to the processing unit 1206. The processing unit 1206, which has acquired the subject candidate list, displays the acquired subject candidates on the display unit 1201 in the same manner as the first embodiment.

As described above, in the modification of the embodiments of the present invention, the image capturing device, that is, the image capturing terminal, may be configured to have a communication unit (transmission unit) that transmits the information including the position of the terminal to the photographing support device, that is, the external terminal.

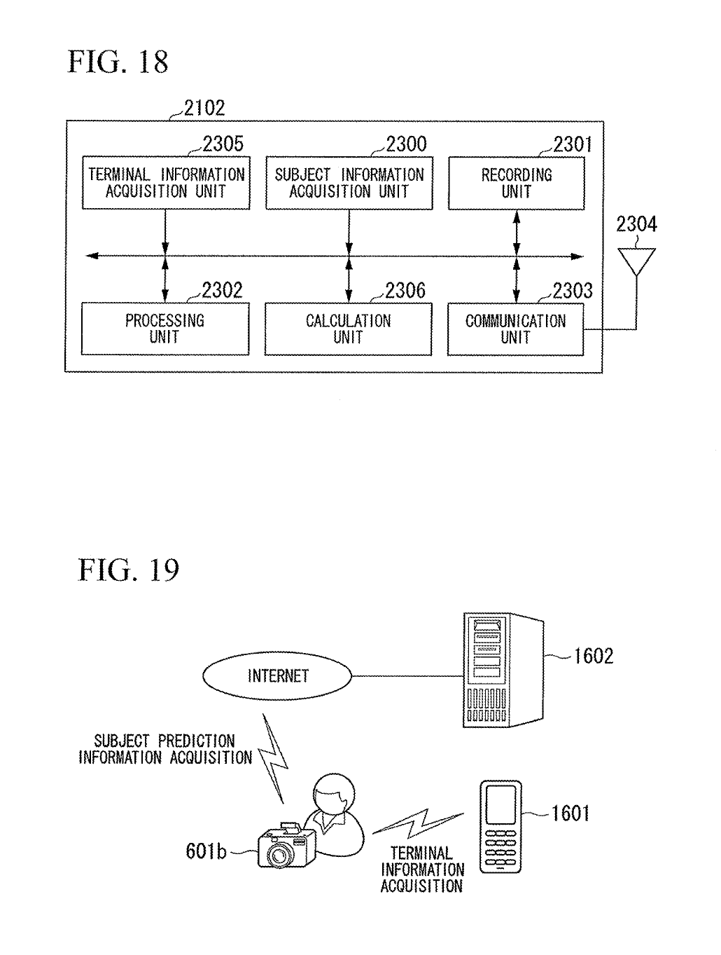

Also, as an example of combining and using the photographing support device according to the second embodiment with the image capturing device according to the first embodiment of the invention, the image capturing device may be configured as illustrated in FIGS. 17 and 18. The example illustrated in FIGS. 17 and 18 is an example that is configured by combining the photographing support device 2102 that is a modification of the image capturing device 602a illustrated in FIG. 15 with the image capturing device 2101 that is a modification of the image capturing device 101 according to the first embodiment.

In the image capturing device 2101 illustrated in FIG. 17, the subject information acquisition unit 204 and the terminal information acquisition unit 203 of the image capturing device 101 illustrated in FIG. 2 are not installed. The image capturing device 2101 is additionally provided with a communication unit 2208 and an antenna 2209. The photographing support device 2102 illustrated in FIG. 18 is additionally provided with a processing unit 2302.

The photographing support device 2102 acquires the terminal information in the same manner as the photographing support device 602a illustrated in FIG. 15. The image capturing device 2101 receives the terminal information acquired by the photographing support device 2102 by the communication unit 2208 through the antenna 2209. Also, the image capturing device 2101 receives the subject information such as the subject list and the like read by the subject information acquisition unit 2300 by the communication unit 2208 through the antenna 2209. The subject information received by the image capturing device 2101 may be the subject position prediction information that is read and calculated by the processing unit 2302 from the terminal information and the subject information read from the recording unit 2301. The subject position prediction information calculated by the processing unit 2302 includes the position of the subject that is selected from the subject information that includes the position of each subject based on the position of the terminal and the position of the subject included in the subject information.

As described above, in the modification of the embodiments of the present invention, the image capturing device, that is, the image capturing terminal, may be configured to have a communication unit (reception unit) that receives information including the position of the terminal and the image capturing direction from the photographing support device, that is, the external terminal.

As described above, in the modification of the embodiments of the present invention, the image capturing device, that is, the image capturing terminal, may be configured to have a communication unit (reception unit) that receives the subject information including the position of each subject from the photographing support device, that is, the external terminal.

Further, in the modification of the embodiments of the present invention, the image capturing device, that is, the image capturing terminal, may be configured to have a communication unit (reception unit) that receives information including the position of the subject selected from the subject information including the positions of each subject based on the position of the terminal and the position of the subjects included in the subject information from the photographing support device, that is, the external terminal.

The photographing support device according to the embodiments of the present invention ay be a server that is accessible through the Internet as illustrated in FIG. 19 under the circumstances where the image capturing device is capable of accessing the Internet. Also, in the first and second embodiments, as illustrated in FIG. 19, the terminal information of the image capturing device may be acquired from an external device that measures the position information such as a GPS logger.

In FIG. 19, the image capturing device 601b receives the terminal information from an external device 1601, and transmits the terminal information to a server 1602. The server 1602 performs calculation of the subject position prediction information based on the terminal information, and transmits the result of the calculation to the image capturing device 601b. As described above, the configurations are not limited to those in the two embodiments as described above, and configuration elements may be increased or decreased unless they depart from the scope of the invention.

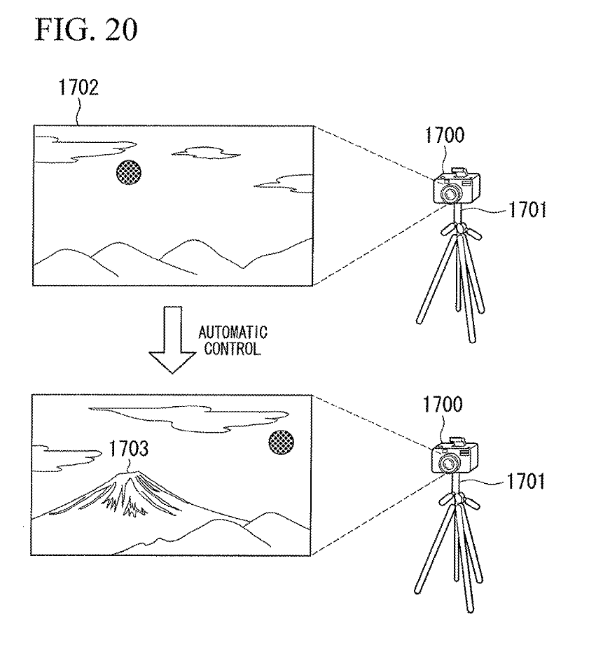

For example, in the first embodiment of the present invention, the position in which the subject exists is notified the user using the display unit. However, as illustrated in FIG. 20, the subject may be automatically placed within the range of the real-time image. FIG. 20 illustrates a system in which an automatic control unit 1701 automatically places a subject 1703 within a range of a real-time image 1702 in the case where the subject 1703 does not exist within the range of the real-time image 1702 that is acquired using an image capturing device 1700.

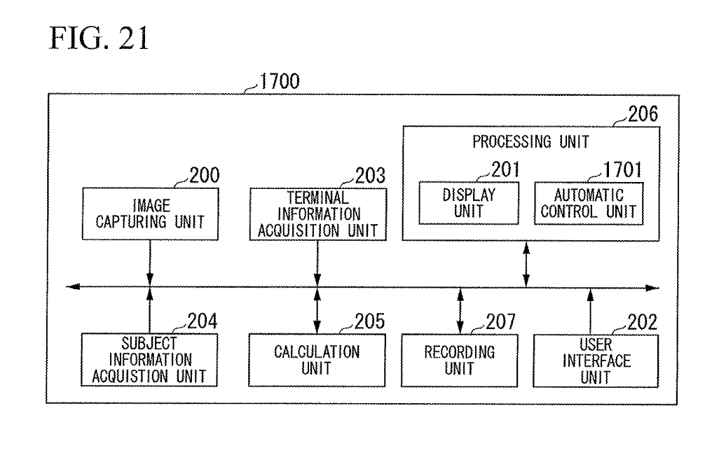

FIG. 21 is a block diagram illustrating a configuration of the image capturing device 1700. The block diagram illustrated in FIG. 21 is almost the same as the block diagram of the image capturing device 101 according to the first embodiment as illustrated in FIG. 2, but the processing unit is additionally provided with the automatic control unit 1701. The automatic control unit 1701 is, for example, a platform provided with a driving mechanism that can perform automatic control. In the case where the subject does not exist within the display range of the real-time image as a result of performing the calculation through the calculation unit 205, the automatic control unit 1701 controls the direction of the image capturing device 1700 based on the direction in which the subject exists and the elevation/depression angle and the direction of the image capturing device 101. Other configurations are the same as those as described according to the first embodiment.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. An image capturing system comprising:
an image capturing terminal; and
an external terminal communicating with the image capturing terminal; wherein
either the image capturing terminal or the external terminal comprises:
a terminal information acquisition unit having a sensor detecting a position of a local terminal and an image capturing direction of the image capturing terminal and acquiring the position of the local terminal and the image capturing direction of the image capturing terminal from the sensor; and
a calculation unit calculating a relative positional relationship between a subject and the local terminal based on a position of the subject selected based on the position of the local terminal, the position of the local terminal and the image capturing direction of the image capturing terminal, and
the image capturing terminal comprises an instruction unit instructing a correction of the position of the local terminal or the image capturing direction of the image capturing terminal based on a calculation result information indicating a calculation result of the relative positional relationship calculated by the calculation unit.

2. The image capturing system according to claim 1, wherein
either the image capturing terminal or the external terminal further comprises:
a storage unit storing a subject information including a position of respective subjects; and
a selection unit selecting the subject based on the position of the local terminal and the position of the subject included in the subject information, and
the calculation unit calculates a relative positional relationship between the local terminal and the subject selected in the selection unit based on the position of the subject selected in the selection unit, the position of the local terminal and the image capturing direction of the image capturing terminal.

3. An image capturing terminal included in the image capturing system according to claim 1, wherein the image capturing terminal comprises at least the instruction unit according to claim 1, the image capturing terminal comprises an instruction unit instructing a correction of the position of the local terminal or the image capturing direction of the image capturing terminal based on a calculation result information indicating a calculation result of the relative positional relationship calculated by the calculation unit.

4. The image capturing terminal according to claim 3, further comprising the calculation unit according to claim 1, a calculation unit calculating a relative positional relationship between a subject and the local terminal based on a position of the subject selected based on the position of the local terminal, the position of the local terminal and the image capturing direction of the image capturing terminal.

5. An image capturing terminal included in the image capturing system according to claim 2, further comprising:
the instruction unit according to claim 1 the image capturing terminal comprises an instruction unit instructing a correction of the position of the local terminal or the image capturing direction of the image capturing terminal based on a calculation result information indicating a calculation result of the relative positional relationship calculated by the calculation unit; and
the selection unit according to claim 2 a selection unit selecting the subject based on the position of the local terminal and the position of the subject included in the subject information.

6. An external terminal included in the image capturing system according to claim 1, wherein the external terminal comprises at least the terminal information acquisition unit according to claim 1 a terminal information acquisition unit having a sensor detecting a position of a local terminal and an image capturing direction of the image capturing terminal and acquiring the position of the local terminal and the image capturing direction of the image capturing terminal from the sensor.

7. The external terminal according claim 6, further comprising the calculation unit according to claim 1 a calculation unit calculating a relative positional relationship between a subject and the local terminal based on a position of the subject selected based on the position of the local terminal, the position of the local terminal and the image capturing direction of the image capturing terminal.

8. The image capturing system according to claim 1 or 2, wherein the instruction unit instructs correction of the position and the image capturing direction of the local terminal or the image capturing terminal according to any one of changes of display, audio, vibration, and weight.

9. The image capturing system according to claim 1, wherein the image capturing terminal further comprises a correction unit having a driving mechanism that corrects the position or the image capturing direction of the local terminal or the image capturing terminal based on the instruction from the instruction unit.

10. The image capturing system according to claim 1, wherein the position of the subject and the position of the local terminal are three-dimensional positions, and the image capturing direction of the image capturing terminal is a direction within a three-dimensional space.

11. The image capturing system according to claim 1, wherein the calculation unit calculates the relative positional relationship between the subject and the local terminal at a predetermined time based on the position of the subject that is selected based on the position of the local terminal, the time when the subject exists in the position, and the position and the image capturing direction of the local terminal and the image capturing terminal.

12. The image capturing system according to claim 1, further comprising a setting unit setting a predetermined time.

13. The image capturing system according to claim 1, wherein
the terminal information acquisition unit further detects an angle of view from a state of the image capturing unit,
the calculation unit further determines whether the subject is outside or inside the angle of view based on the calculation result information, and
the instruction unit instructs a correction of the position or the image capturing direction of the local terminal only in the case where the subject is outside the angle of view.

14. An image capturing method comprising the steps of:
acquiring, by a terminal information acquisition unit having a sensor detecting a position and an image capturing direction of a local terminal, the position and the image capturing direction of the local terminal from the sensor;
selecting, by a selection unit, a subject from subject information including positions of respective subjects based on the position of the local terminal and the positions of the subjects included in the subject information;
calculating, by a calculation unit, a relative positional relationship between the subject and the local terminal based on a position of the selected subject and the position and the image capturing direction of the local terminal; and
instructing, by a correction unit, correction of the position or the image capturing direction of the local terminal based on a result of the calculation calculated by the calculation unit.
